(19) United States
(12) Patent Application Publication
(10) Pub. No.: US 2015/0277703 A1
(43) Pub. Date: Oct. 1, 2015

(54) APPARATUS FOR DIGITAL SIGNAGE ALERTS

(71) Applicant: Stephen Rhett DAVIS, Nashville, TN (US)

(72) Inventor: Stephen Rhett DAVIS, Nashville, TN (US)

(21) Appl. No.: 14/631,827

(22) Filed: Feb. 25, 2015

Related U.S. Application Data
(60) Provisional application No. 61/944,348, filed on Feb. 25, 2014.

(51) Int. Cl. G06F 3/0481; G06F 3/0484

(52) U.S. Cl. CPC G06F 3/04817; G06F 3/04847; G06Q 50/22

(57) ABSTRACT

An apparatus for displaying icons and warnings about healthcare conditions for a patient through a display screen. The screen may be a touchscreen to facilitate authorized healthcare user interaction. The display screen is located in proximity to a patient or the patient's room. The display screen provides a public display mode displaying icons and warnings symbol related to one or more conditions for the patient, but without displaying information that may violate the patient's privacy. The display screen further provides an authorized display mode accessible only by authorized users, such as healthcare workers. Authorized users may thereby gain access to more specific information identifying the one or more conditions, and complete a checklist of healthcare procedures and protocols related to said conditions. Information about authorized user access and checklist completion may be stored to document compliance.

This application claims benefit of and priority to U.S. Provisional Application No. 61/944,348, filed Feb. 25, 2014, by Stephen Rhett Davis, and is entitled to that filing date for priority. The specification, figures and complete disclosure of U.S. Provisional Application No. 61/944,348 are incorporated herein by specific reference for all purposes.

### FIELD OF INVENTION

This invention relates to an apparatus and system for displaying signs that provide alerts as to patient conditions.

### BACKGROUND OF THE INVENTION

Healthcare Acquired Conditions (“HAC”) are severe, largely preventable complications that result from negligent patient care provided by a hospital or medical or healthcare facility. At present, there are ten categories of HAC conditions, including, but not limited to, blood incompatibility, pressure ulcers, falls and trauma, urinary and vascular catheter infections, and surgical site infections.

It is estimated that the healthcare industry spends over $35 billion to treat the occurrence of HACs. Within the past decade, the prevalence of HACs has exceeded 5% of all admitted patients and is responsible for more than 100,000 U.S. deaths annually. More people die in the U.S. from HAC-related complications than from breast cancer and heart disease combined.

To combat this problem, U.S. laws mandate that all medical facilities make public their rate of HAC related illness and provide financial penalties. Currently, treatment of HACs are the financial obligation of the medical facility in which they occur, and are ineligible for reimbursement by Medicare, Medicaid, third party insurers. In addition, medical facilities are required to provide HAC quarterly reports, and the results are then published on a website.

At present, various physical signage systems have been devised for placement outside of patient rooms to communicate critical HAC-related patient information to doctors, nurses, clinicians and other healthcare providers prior to entering the room and engaging with the patient. However, due to the placement of these signs in public corridors, these physical signs are forbidden from displaying text identifying the patient's condition(s) due to privacy requirements under the Health Insurance Portability and Accountability Act (“HIPAA”) and other laws. Accordingly, existing physical signage systems typically use a representational collection of colored symbols.

However, existing flag or symbol-based patient notification signage has significant limitations. Patient condition symbols typically vary by facility, so healthcare workers who change jobs or work at multiple facilities are required to commit multiple signage systems to memory. Symbols also can be easily confused or misinterpreted, leading to patient mistreatment that exacerbates rather than remedies the conditions. Current system also provide a single layer of limited information, since the number of symbols is limited. Existing physical signage symbols are size-limited tabs placed in symbol housings, and the tabs cannot provide additional information, such as information regarding best practices, for each identified condition. Further, even if a signage library has a large number of unique symbols, the physical signage mechanism may only allow a small number of symbols to be housed and displayed (e.g., 8, 10 or 12 symbol housing configurations). This also requires that a large number of symbol tabs be stored at each facility for potentially hundreds of exterior patient room signs. And finally, there is a protracted update process. The physical signs can only be updated by physical replacement at the point of location. If new conditions are identified, a new physical tab has to be designed, manufactured, and shipped to the client facility before the new symbol can be displayed. This process often can take months.

Accordingly, what is needed is an improved apparatus and system for displaying signs that provide alerts as to patient conditions.

### SUMMARY OF INVENTION

In various exemplary embodiments, the present invention comprises an apparatus or device that displays patient condition icons and related data. The device can be mounted, permanently or removably, inside or outside a patient room. The device may be mounted on a wall, a door, a bed frame, the ceiling, or the like. The device may be mounted in a variety of ways, including a flat mount, a partially-movable mount, an articulated or extendable arm, or the like.

In one exemplary embodiment, the device comprises an electronic or digital display or screen. The display may be a touchscreen display. The device may further comprise a mechanical keypad or keyboard, although an electronic keypad or keyboard may be presented on the screen, and implemented through a touchscreen display. The device may be connected, wired or wirelessly (e.g., Ethernet, cable, wifi, Bluetooth, or the like), to one or more networks or servers, including, but not limited to, local area networks or the Internet through appropriate ports or communication components. The device may further comprise a processor or microprocessor coupled to a computer memory, and one or more storage devices. The processor or microprocessor controls the display, various interfaces and interaction with users, communications with external servers, and the other operations described herein. The components of the device are contained in a body or housing. The device may further comprise a camera facing the front of the device, a fingerprint or biometric reader, one or more microphones, and one or more speakers.

When a patient room is occupied, the screen display shows relevant patient condition icons and information. Initially, when a new patient is assigned to the room, the device is accessed by an authorized user (i.e., healthcare facility worker or personnel), either directly through the device itself, or remote through the wired or wireless connection. In the case of direct access through a touchscreen display, the authorized user touches the screen to access a login keypad. Alternative forms of authorized access may be used, depending on facility security preferences.

After obtaining access, the authorized user then uses the device to select specific patient healthcare conditions to be displayed for the particular patient. This screen display allows the user to select particular icons representing particular conditions. The icons may be custom-designed, or conform to a standard set of accepted icons. The icons are displayed along with a short definition to ensure that all icons are appropriately identified for the user. The user then selects the condition icon or icons that are applicable for the particular patient.

Multiple icons can be presented on a screen. The number of icons presented can vary from a single icon to many icons, depending on the size of the display and the resolution of the screen. Several pages of icons may be presented, and the user can move between pages. In one embodiment, the total number of pages of icons may be shown as a row of radio buttons, with the current page filled or marked. The user can then move to the desired page by selecting the corresponding radio button. Alternatively, page arrows on the sides of the screen may be used, or hand gestures or “swipes” across the face of the display (if a touchscreen is used).

In one embodiment, once the user has selected all desired icons, the user selects the “Enter” option to proceed (by touching the touch screen, or otherwise selecting the option in a manner similar to that described above for interfacing with the device). The “Clear” option may be used to clear the last selection (i.e., unmark it). Pressing the “Clear” option for a certain period of time (e.g., 3 seconds) may clear all selections, allowing the user to start anew. Alternatively, the use may select the “Enter” option after each icon is selected to indicate that the current selected icon should be added to the list of icons to be used for that patient. The user then continues to review and select other applicable icons.

As part of the icon screens available for the user, or separate from the icon screens, the user may be presented with one or more specific industry or facility warnings. The user selects any applicable warnings in a similar manner to the condition icons (e.g., a check mark indicates that the “Do Not Enter” sign is selected in this case). Multiple warnings may be presented on a single page, and there may be multiple pages of warnings.

After confirming selection of the warnings (such as with the “Enter” option), the user is presented with the proposed “public display mode” for the device based upon the selected condition icons and warnings. The public display mode complies with applicable privacy standards and regulations (e.g., HIPAA privacy standards) by displaying only the selected patient condition icons and warnings without accompanying icon definitions. In addition, certain additional or ancillary information may be displayed by the healthcare facility, as it deems appropriate, such as, but not limited to, the facility logo or name, date, and time. Once the public display mode is approved and confirmed, viewers can only see the public display mode and cannot access more detailed information or manipulate the device with the appropriate authorization (i.e., by logging into the device as described herein).

In several exemplary embodiments, prior to engaging with a patient, all authorized healthcare workers log into the device by entering authorization credentials or passwords. Login data is presented after a healthcare worker has logged in and authorization has been verified. This data includes the identity of the healthcare worker, the time, and the identity of the patient. The condition icons and warnings are displayed, along with text identifying the condition or warning. This ensures proper identification of applicable patient conditions. A checklist option also may be presented, which upon selection allows the authorized user to access recommended best practice checklists for care of and engagement with the patient.

### BRIEF DESCRIPTION OF THE DRAWINGS

FIG. 1 shows a view of a device in accordance with an embodiment of the present invention.

FIG. 2 shows a view of a login keypad for the device of FIG. 1.

FIG. 3 shows a view of a patient condition icon and text display for the device of FIG. 1.

FIG. 4 shows a view of a selected patient condition icon for the device of FIG. 1.

FIG. 5 shows a view of a final selected patient condition icon for the device of FIG. 1.

FIG. 6 shows a view of a public display mode for the device of FIG. 1.

FIG. 7 shows a view of an access screen for detailed patent condition icon data for the device of FIG. 1.

FIG. 8 shows a view of a review screen for selected patient condition icons for the device of FIG. 1.

FIG. 9 shows a view of a completed checklist of patient condition best practices for the device of FIG. 1.

FIG. 10 shows a view of completed login transaction data for the device of FIG. 1.

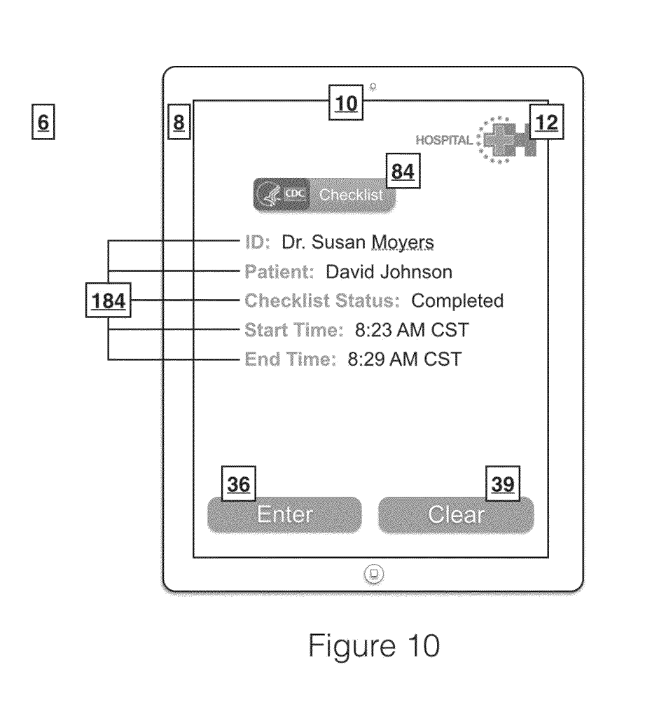

### DETAILED DESCRIPTION OF EXEMPLARY EMBODIMENTS

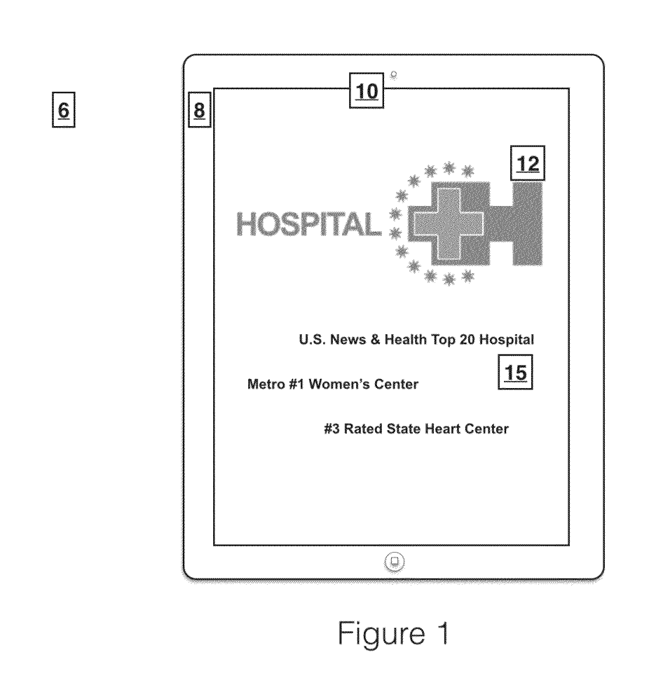

In various exemplary embodiments, as seen in FIG. 1, the present invention comprises an apparatus or device 2 that displays patient condition icons and related data. The device can be mounted, permanently or removably, inside or outside a patient room. The device may be mounted on a wall 6, a door, a bed frame, the ceiling, or the like. The device may be mounted in a variety of ways, including a flat mount, a partially-movable mount, an articulated or extendable arm, or the like.

In one exemplary embodiment, the device 6 comprises an electronic or digital display or screen 8. The display may be a touchscreen display. The device may further comprise a mechanical keypad or keyboard, although an electronic keypad or keyboard may be presented on the screen, and implemented through a touchscreen display. The device may be connected, wired or wirelessly (e.g., Ethernet, cable, wifi, Bluetooth, or the like), to one or more networks or servers, including, but not limited to, local area networks or the Internet through appropriate ports or communication components. The device may further comprise a processor or microprocessor coupled to a computer memory, and one or more storage devices. The processor or microprocessor controls the display, various interfaces and interaction with users, communications with external servers, and the other operations described herein. The components of the device are contained in a body or housing. The device may further comprise a camera facing the front of the device, a fingerprint or biometric reader, one or more microphones, and one or more speakers.

When a patient room is empty, the screen display 8 shows a default or “screen saver” display. For example, this may be promotional information or material, such as, but not limited to, a facility logo, promotional messages, a general information menu, award announcements, service listings, and the like.

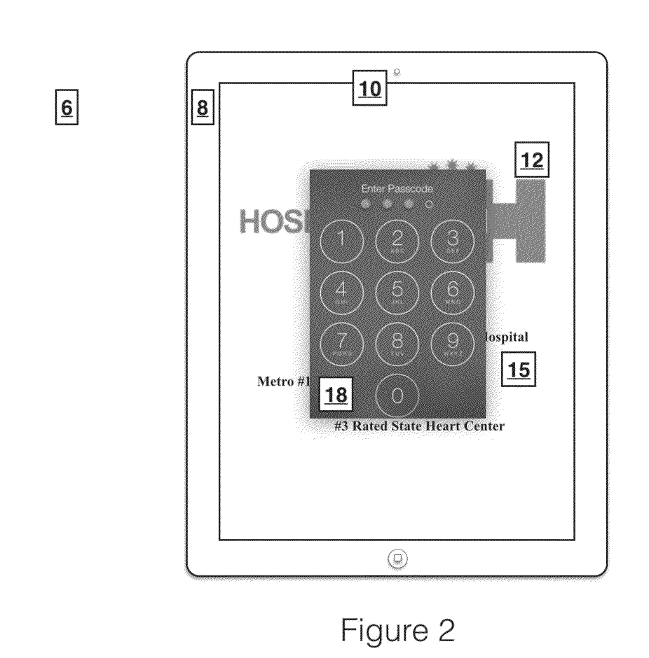

When a patient room is occupied, the screen display 8 shows relevant patient condition icons and information. Initially, when a new patient is assigned to the room, the device is accessed by an authorized user (i.e., healthcare facility worker or personnel), either directly through the device itself, or remote through the wired or wireless connection. In the case of direct access through a touchscreen display, the authorized user touches the screen to access a login keypad 18, as seen in FIG. 2. Alternative forms of authorized access may be used, depending on facility security preferences, such as biometric identification (e.g., fingerprint scanner), card readers, Near Field Communications (NFC), Radio Frequency Identification (RFID) systems, other low-cost, low-powered transmitters such as iBeacon by Apple, or combinations thereof. In one embodiment, the device comprises a camera or visual imaging device facing the front of the device to take images of the user for facial feature matching for access.

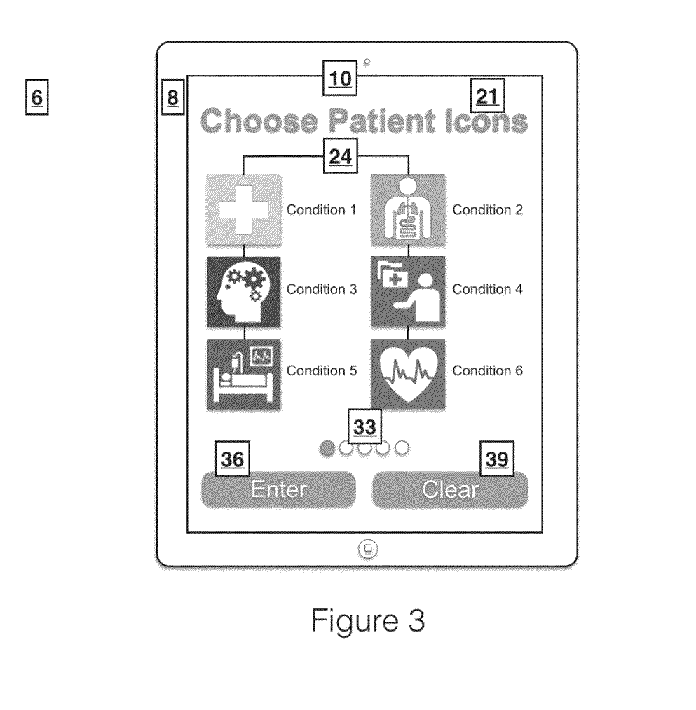

After obtaining access, the authorized user then uses the device to select specific patient healthcare conditions to be displayed for the particular patient. FIG. 3 is an example of a screen display allowing the user to select particular icons 24 representing particular conditions. The icons may be custom-designed, or conform to a standard set of accepted icons. The icons are displayed along with a short definition 26 to ensure that all icons are appropriately identified for the user. The user then selects the condition icon or icons that are applicable for the particular patient.

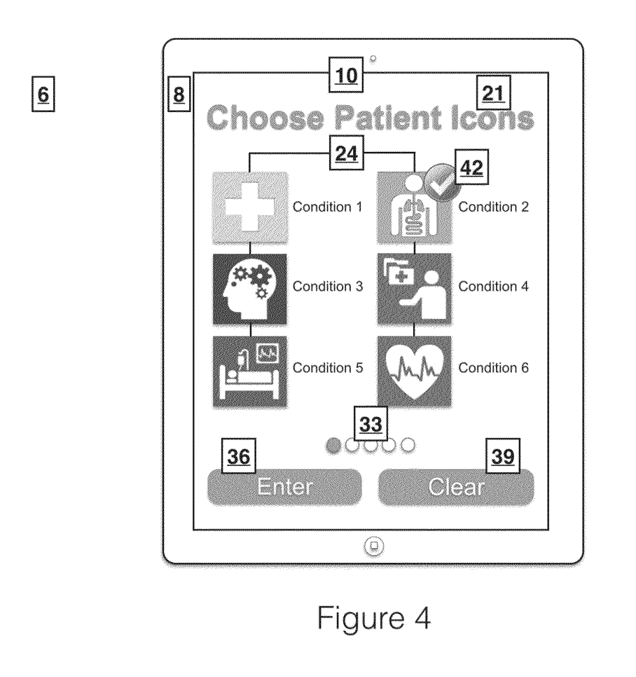

As seen in FIG. 3, multiple icons can be presented on a screen. The number of icons presented can vary from a single icon to many icons, depending on the size of the display and the resolution of the screen. Several pages of icons may be presented, and the user can move between pages. In one embodiment, the total number of pages of icons may be shown as a row of radio buttons 33, with the current page filled or marked. The user can then move to the desired page by selecting the corresponding radio button. Alternatively, page arrows on the sides of the screen may be used, or hand gestures or “swipes” across the face of the display (if a touchscreen is used).

Where the touchscreen display is used, the user taps the screen above the condition or conditions being selected. Alternatively, a pointer or other indicator can be used with a mouse, trackball, pressure pad, arrow keys or other interface device. As seen in FIG. 4, a selected icon/condition is then marked (such as by a check mark 42 or other indicator), highlighted, or otherwise identified as having been selected. As noted above, one or more icons can be selected by the user.

In one embodiment, once the user has selected all desired icons, the user selects the “Enter” option 36 to proceed (by touching the touch screen, or otherwise selecting the option in a manner similar to that described above for interfacing with the device). The “Clear” option 39 may be used to clear the last selection (i.e., unmark it). Pressing the “Clear” option for a certain period of time (e.g., 3 seconds) may clear all selections, allowing the user to start anew. Alternatively, the use may select the “Enter” option 36 after each icon is selected to indicate that the current selected icon should be added to the list of icons to be used for that patient. The user then continues to review and select other applicable icons.

In simple form, an icon simply identifies the presence of a condition. The severity or intensity of the condition may be contained in the test available to an authorized user, as described below. However, in alternative embodiments, the severity or intensity of the condition may be displayed in nonverbal fashion as part of the public display mode through a variety of means. The color of the icon may change (i.e., blue, yellow, red, to indicate increasing intensity). The size of the icon may change (i.e., small, medium, large, to indicate increasing intensity). The hue or boldness of the icon may change (brighter hues, or bolder lines in the icon, may indicate higher intensity). There may be slight variations in the appearance of the condition icon for the same condition. A number may be associated with each icon to indicate intensity, or a sliding scale or bar chart or graph. Other symbols may also be associated with each icon to indicate intensity (e.g., a exclamation point, !).

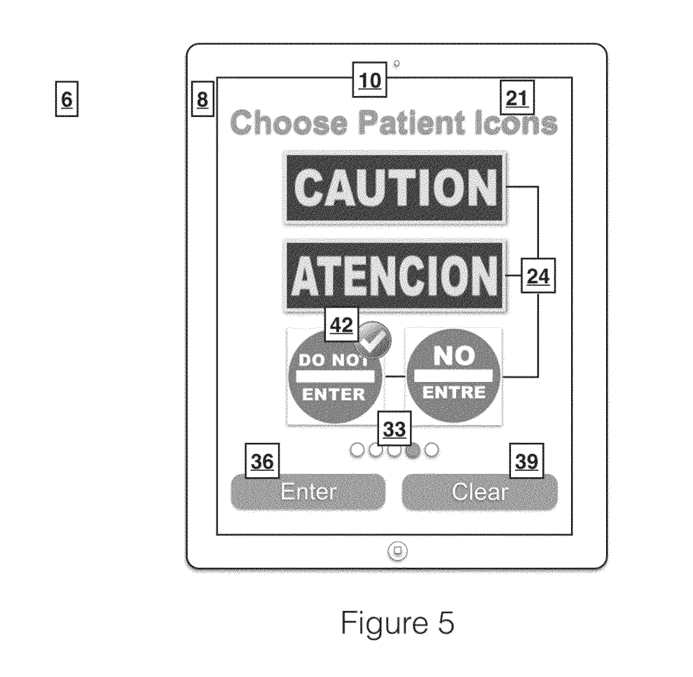

As part of the icon screens available for the user, or separate from the icon screens, the user may be presented with one or more specific industry or facility warnings 25, as seen in FIG. 5. The user selects any applicable warnings in a similar manner to the condition icons (e.g., a check mark 44 indicates that the “Do Not Enter” sign is selected in this case). Multiple warnings may be presented on a single page, and there may be multiple pages of warnings.

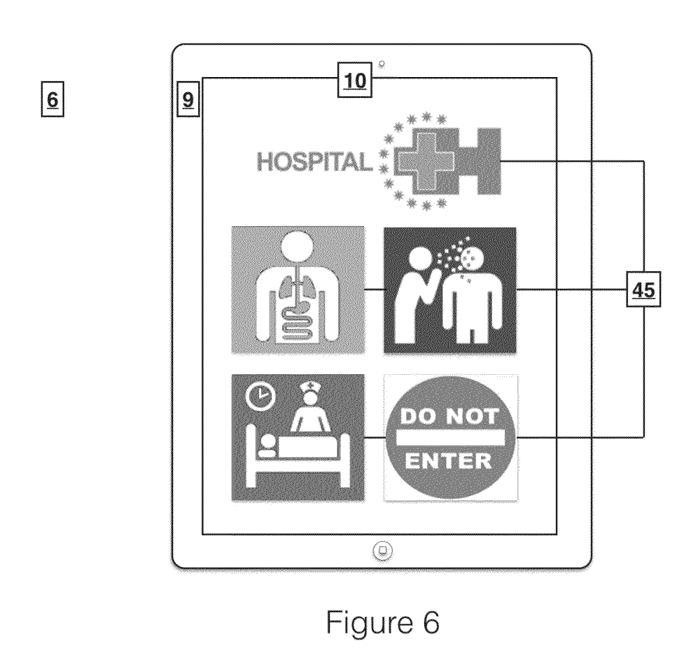

After confirming selection of the warnings (such as with the “Enter” option), the user is presented with the proposed “public display mode” for the device based upon the selected condition icons and warnings, as seen in FIG. 6. The public display mode complies with applicable privacy standards and regulations (e.g., HIPAA privacy standards) by displaying only the selected patient condition icons 46 and warnings 48 without accompanying icon definitions. In addition, certain additional or ancillary information may be displayed by the healthcare facility, as it deems appropriate, such as, but not limited to, the facility logo or name, date, and time. Once the public display mode is approved and confirmed, viewers can only see the public display mode and cannot access more detailed information or manipulate the device with the appropriate authorization (i.e., by logging into the device as described herein).

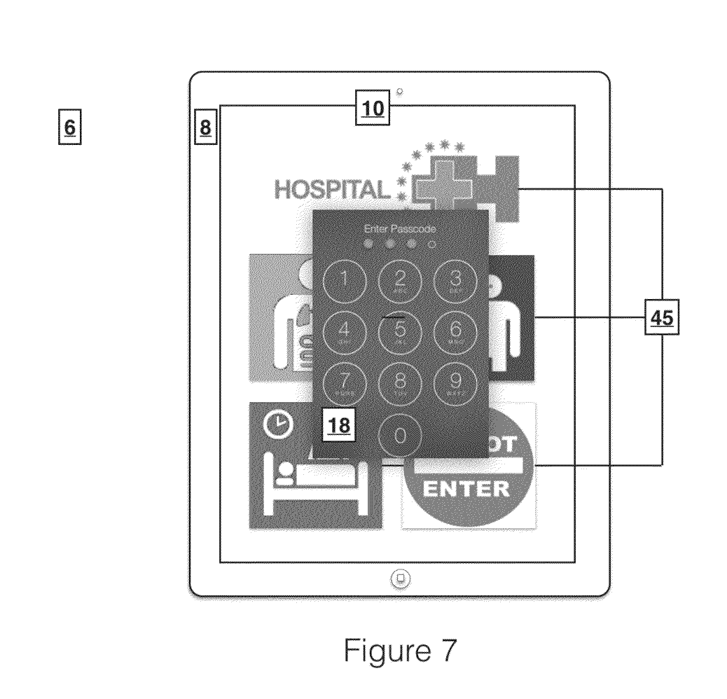

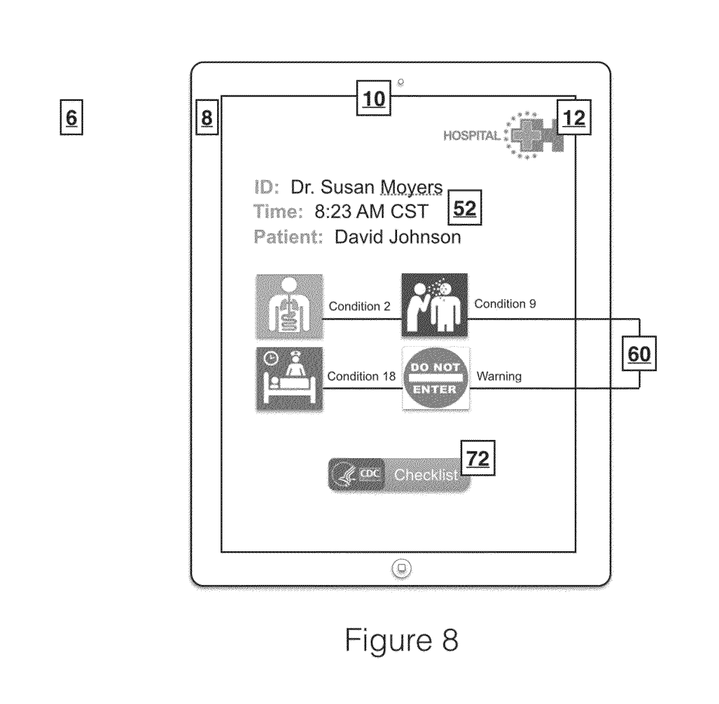

In several exemplary embodiments, prior to engaging with a patient, all authorized healthcare workers log into the device by entering authorization credentials or passwords, as seen in FIG. 7. FIG. 8 shows an example of login data 52 after a healthcare worker has logged in and authorization has been verified. This data includes the identity of the healthcare worker, the time, and the identity of the patient. The condition icons and warnings are displayed, along with text identifying the condition or warning 60. This ensures proper identification of applicable patient conditions. A checklist option 72 also may be presented, which upon selection allows the authorized user to access recommended best practice checklists for care of and engagement with the patient.

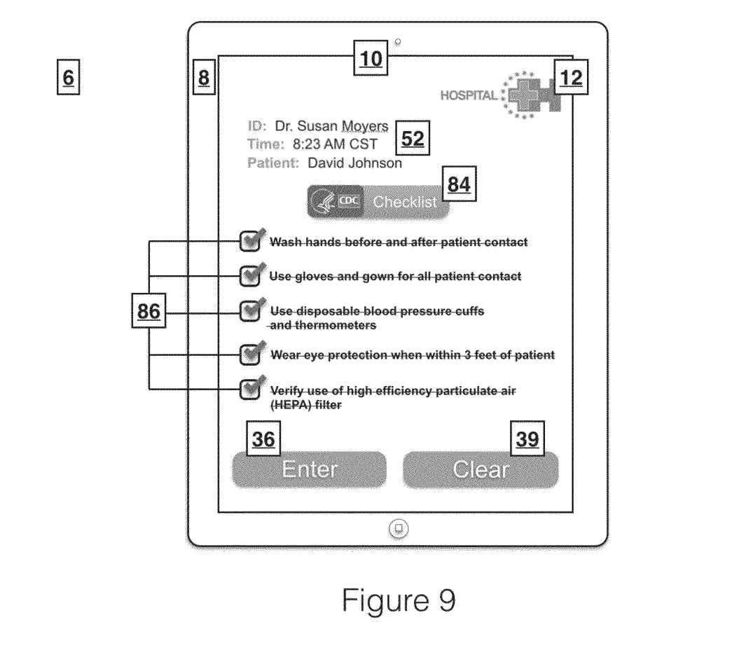

Upon selecting the checklist option, the device displays a checklist screen as seen in FIG. 9. The display may include the login data 52, a facility name or icon 12, a static checklist icon or button 84, and a list of best practices (i.e., healthcare procedures and protocols) 86. In one embodiment, the list may be specific to a particular selected condition, and thus there may be multiple lists. Alternatively, the list may assemble all best practices for all of the selected patient conditions, combined into a single list. The combined list is unique for each displayed combination of conditions, and changes as conditions icons are removed, replaced, or added for the particular patient.

In several embodiments, once the checklist option is selected and the best practice list presented to the user, the user must check off each item indicating that best practices were followed (the device can display the item as complete with a checkmark, by a line drawn through the text of the item, or combinations thereof). When all best practice items are checked off, the user selects the Enter option to advance. The Clear option can be used to clear all the last checked item, or all checked items, in a similar manner to the selection of condition icons described above.

After completion of the checklist, the user is shown a display of the login transaction data with completed checklist confirmation. The user can then exit or log out of the device by selecting the Enter option (which may be presented as a logout option). The device then returns to public display mode. This information (i.e., login transaction data and successful checklist completion) is stored in the device, and may be subsequently transmitted or transferred to a server or database in the facility or other network (e.g., Internet, cloud) to provide a record of compliance with appropriate protocols for identified conditions.

The wired or wireless connection provides several advantages. First, it allows remote interaction with the device, so that condition icon and warning selection and patient information can be input, selected, and updated remotely, such as from a nurse's station or a physician's office (which may be at the facility or offsite). A physician reviewing patient lab results, for example, can thus immediately update the icon display with the appropriate condition and warnings without the substantial delay caused by prior art systems.

Second, it allows icons, warnings, and related information (e.g., best practices) to be updated immediately, around-the-clock, whenever needed or whenever new information or procedures are provided or released. In one embodiment, the icons, warnings and checklists are provided by a central service provider, which can update multiple devices from a remote location with one or more central computer servers whenever new icons and warnings are developed, or new best practices identified.

The device content may be accessed, modified or manipulated (e.g., added, removed, or the like) directly, through a memory stick or thumb drive inserted into an appropriate USB or other port in the device, through a cell phone or other mobile computing device (e.g., tablet computer, laptop computer) in communication with the device, or a personal computer or computer workstation located in the vicinity of the device or remotely. In some embodiments, an Internet webpage or dashboard may be provided. This webpage or dashboard may indicate the status of all connected devices within a system or parts of a system (e.g., a facility, a specific ward or floor in the facility, and the like). In one embodiment, the dashboard may be displayed on a wall-mounted monitor, computer workstation, or mobile device (e.g., by a secure mobile application).

It should be noted that there may be different levels of authorized user; i.e., some users may have full access to the device and thus be permitted to add or change selected condition icons and warnings, while others may have limited access, and thus only be able to read the additional information or complete a checklist.

In several alternative embodiments, the authorized user can select a condition icon or its name to obtain further detailed information about the condition. This can be done from the icon selection screens to provide the user additional information about whether a particular condition icon is applicable, and also during subsequent entry into the patient room. In addition, the user may select a checklist item and obtain more detailed information about that checklist item.

In yet a further embodiment, interface with the device is through passive (non-touch) controls, such as gesture-recognition (i.e., the camera recognizes gestures made by the user to control interaction), or voice control. The device in some embodiments thus may comprise one or more microphones and/or speakers. These variations avoid the possible spread of contaminants through touch.

Unlike current systems where the number of symbols/icons is limited, the number of symbols in the icon and warning library for the device is essentially unlimited. New symbols are easily added and distributed to multiple devices. The device also provides quick and easy access to additional information about the icons and warning that current systems cannot provide, thereby avoiding confusion or errors by healthcare workers.

In some embodiments, the device may be mobile, and transported throughout the facility by authorized healthcare facility or hospital personnel. The device displays warning information based on location or proximity to particular patients. This location detection may be GPS-based, a room number or identifier entered by the user, or through NFC, Bluetooth or RFID communications.

While the above device has been described in the context of a healthcare facility or hospital, it may be used in a number of environments where icons and warning signs are displayed, or checklists of best practices are used. Thus, the device may be used in (but is not limited to) hospitals, physician offices, surgical centers, long term care facilities, hospice and assisted living facilities, care for the disabled, child care centers, veterinary care facilities, bio-hazardous environments, manufacturing or agricultural facilities, aviation or engineering locations, food packaging or preparation facilities, construction sites, refuse and recycling operations, railway and mass transportation facilities, military bases and camps, energy and petroleum exploration and refining locations, equipment maintenance and repair facilities, and electrical line and generator operations (including maintenance and repair).

In order to provide a context for the various aspects of the invention, the following discussion provides a brief, general description of a suitable computing environment in which the various aspects of the present invention may be implemented. A computing system environment is one example of a suitable computing environment, but is not intended to suggest any limitation as to the scope of use or functionality of the invention. A computing environment may contain any one or combination of components discussed below, and may contain additional components, or some of the illustrated components may be absent. Various embodiments of the invention are operational with numerous general purpose or special purpose computing systems, environments or configurations. Examples of computing systems, environments, or configurations that may be suitable for use with various embodiments of the invention include, but are not limited to, personal computers, laptop computers, computer servers, computer notebooks, hand-held devices, microprocessor-based systems, multiprocessor systems, TV set-top boxes and devices, programmable consumer electronics, cell phones, personal digital assistants (PDAs), network PCs, minicomputers, mainframe computers, embedded systems, distributed computing environments, and the like.

Embodiments of the invention may be implemented in the form of computer-executable instructions, such as program code or program modules, being executed by a computer or computing device. Program code or modules may include programs, objects, components, data elements and structures, routines, subroutines, functions and the like. These are used to perform or implement particular tasks or functions. Embodiments of the invention also may be implemented in distributed computing environments. In such environments, tasks are performed by remote processing devices linked via a communications network or other data transmission medium, and data and program code or modules may be located in both local and remote computer storage media including memory storage devices.

In one embodiment, a computer system comprises multiple client devices in communication with at least one server device through or over a network. In various embodiments, the network may comprise the Internet, an intranet, Wide Area Network (WAN), or Local Area Network (LAN). It should be noted that many of the methods of the present invention are operable within a single computing device.

A client device may be any type of processor-based platform that is connected to a network and that interacts with one or more application programs. The client devices each comprise a computer-readable medium in the form of volatile and/or nonvolatile memory such as read only memory (ROM) and random access memory (RAM) in communication with a processor. The processor executes computer-executable program instructions stored in memory. Examples of such processors include, but are not limited to, microprocessors, ASICs, and the like.

Client devices may further comprise computer-readable media in communication with the processor, said media storing program code, modules and instructions that, when executed by the processor, cause the processor to execute the program and perform the steps described herein. Computer readable media can be any available media that can be accessed by computer or computing device and includes both volatile and nonvolatile media, and removable and non-removable media. Computer-readable media may further comprise computer storage media and communication media. Computer storage media comprises media for storage of information, such as computer readable instructions, data, data structures, or program code or modules. Examples of computer-readable media include, but are not limited to, any electronic, optical, magnetic, or other storage or transmission device, a floppy disk, hard disk drive, CD-ROM, DVD, magnetic disk, memory chip, ROM, RAM, EEPROM, flash memory or other memory technology, an ASIC, a configured processor, CDROM, DVD or other optical disk storage, magnetic cassettes, magnetic tape, magnetic disk storage or other magnetic storage devices, or any other medium from which a computer processor can read instructions or that can store desired information. Communication media comprises media that may transmit or carry instructions to a computer, including, but not limited to, a router, private or public network, wired network, direct wired connection, wireless network, other wireless media (such as acoustic, RF, infrared, or the like) or other transmission device or channel. This may include computer readable instructions, data structures, program modules or other data in a modulated data signal such as a carrier wave or other transport mechanism. Said transmission may be wired, wireless, or both. Combinations of any of the above should also be included within the scope of computer readable media. The instructions may comprise code from any computer-programming language, including, for example, C, C++, C#, Visual Basic, Java, and the like.

Components of a general purpose client or computing device may further include a system bus that connects various system components, including the memory and processor. A system bus may be any of several types of bus structures, including, but not limited to, a memory bus or memory controller, a peripheral bus, and a local bus using any of a variety of bus architectures. Such architectures include, but are not limited to, Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computing and client devices also may include a basic input/output system (BIOS), which contains the basic routines that help to transfer information between elements within a computer, such as during start-up. BIOS typically is stored in ROM. In contrast, RAM typically contains data or program code or modules that are accessible to or presently being operated on by processor, such as, but not limited to, the operating system, application program, and data.

Client devices also may comprise a variety of other internal or external components, such as a monitor or display, a keyboard, a mouse, a trackball, a pointing device, touch pad, microphone, joystick, satellite dish, scanner, a disk drive, a CD-ROM or DVD drive, or other input or output devices. These and other devices are typically connected to the processor through a user input interface coupled to the system bus, but may be connected by other interface and bus structures, such as a parallel port, serial port, game port or a universal serial bus (USB). A monitor or other type of display device is typically connected to the system bus via a video interface. In addition to the monitor, client devices may also include other peripheral output devices such as speakers and printer, which may be connected through an output peripheral interface.

Client devices may operate on any operating system capable of supporting an application of the type disclosed herein. Client devices also may support a browser or browser-enabled application. Examples of client devices include, but are not limited to, personal computers, laptop computers, personal digital assistants, computer notebooks, hand-held devices, cellular phones, mobile phones, smart phones, pagers, digital tablets, Internet appliances, and other processor-based devices. Users may communicate with each other, and with other systems, networks, and devices, over the network through the respective client devices.

Thus, it should be understood that the embodiments and examples described herein have been chosen and described in order to best illustrate the principles of the invention and its practical applications to thereby enable one of ordinary skill in the art to best utilize the invention in various embodiments and with various modifications as are suited for particular uses contemplated. Even though specific embodiments of this invention have been described, they are not to be taken as exhaustive. There are several variations that will be apparent to those skilled in the art.

What is claimed is:

1. An apparatus for displaying icons and warnings, comprising:
a device comprising a display screen mounted in a housing, the display screen controlled by a processor or microprocessor coupled to a memory;
said device providing a public display mode, said public display mode comprising one or more graphic icons without accompanying text, each icon corresponding to a particular condition for a patient, and one or more warning signs associated with said patient condition or conditions;
said device further providing an authorized display mode accessible only by authorized users, said authorized display mode comprising said one or more graphic icons, text accompanying each graphic icon identifying the particular condition to which that graphic icon corresponds, and patient identification information.

2. The apparatus of claim 1, wherein the device is mounted outside the patient's room in a healthcare facility.

3. The apparatus of claim 1, wherein the device is mounted inside the patient's room in a healthcare facility.

4. The apparatus of claim 1, said device further providing an authorized checklist mode accessible only by authorized users, said authorized checklist mode comprising one or more lists of healthcare procedures or protocols based on said graphic icons.

5. The apparatus of claim 4, wherein said device store authorized user input with regard to completion status of procedures or protocols on said lists.

6. The apparatus of claim 1, further comprising a forward-facing camera mounted in said housing.

7. The apparatus of claim 1, further comprising a microphone mounted in said housing.

8. The apparatus of claim 1, further comprising one or more electronic communications ports in said housing.

9. The apparatus of claim 1, further comprising a keypad mounted in said housing.

10. The apparatus of claim 1, further comprising a wireless communications card mounted in said housing.

11. The apparatus of claim 1, wherein said icons, warnings, or both, are updated from a location remote from the apparatus.

12. A system for displaying icons and warnings, comprising:
a plurality of icon presentation devices, each icon presentation device comprising a display screen mounted in a housing, the display screen controlled by a processor or microprocessor coupled to a memory;
each of said plurality of icon presentation device providing a public display mode, said public display mode comprising one or more graphic icons without accompanying text, each icon corresponding to a particular condition for a specific patient, and one or more warning signs associated with said patient condition or conditions;
each of said plurality of icon presentation devices further providing an authorized display mode accessible only by authorized users, said authorized display mode comprising said one or more graphic icons, text accompanying each graphic icon identifying the particular condition to which that graphic icon corresponds, and patient identification information.

13. The system of claim 12, wherein each icon presentation device, when activated, is associated only with one particular patient.

14. The system of claim 13, wherein each icon presentation device is located in proximity to the corresponding patient or the patient's room.

15. The system of claim 12, each of said plurality of icon presentation devices further providing an authorized checklist mode accessible only by authorized users, said authorized checklist mode comprising one or more lists of healthcare procedures or protocols based on said graphic icons.

16. The system of claim 15, further comprising at least one central computer server, wherein said plurality of icon presentation devices are in electronic communication, wired or wirelessly, to said central computer server.

17. The system of claim 16, wherein said icons, warnings, or healthcare procedures or protocols, or combinations thereof, are updated on said plurality of icon presentation devices from said at least one central computer server.
